(19) United States
(12) Patent Application Publication
(10) Pub. No.: US 2009/0284648 A1
(43) Pub. Date: Nov. 19, 2009

(54) ARRANGEMENT OF IMAGING MODULE IN DISPLAY DEVICE

(76) Inventors: Fu-Hsiang Sung, Hsin Chu Hsien (TW); Tze-Yun Sung, Hsin Chu Hsien (TW); Huang-Chih Hsu, Hsin Chu Hsien (TW)

Correspondence Address: LEONG C LEI, PMB # 1008, 1867 YGNACIO VALLEY ROAD, WALNUT CREEK, CA, 94598, US

(21) Appl. No.: 12/272,809

(22) Filed: Nov. 18, 2008

(30) Foreign Application Priority Data
May 13, 2008 (TW) TW097208232

(51) Int. Cl. H04N 5/225

(52) U.S. Cl. 348/373; 348/E05.024

(57) ABSTRACT

An embedded imaging module is detachably embedded in a display device to replace the existing fixed web cam that is fixed to the display device for the purposes of enhance flexibility of image taking by a use. In construction, the arrangement includes a display device, a detachable imaging module, a retractable cable, and an auto-focusing lens constituting partly the imaging module. The display device has a circumferential edge having a corner forming a receiving space in which the detachable imaging device is detachably embedded. The retractability of the retractable cable provides connection between the display device and the imaging device to serve as a signal transmission line therebetween in both detached and embedded conditions of the imaging module.

### TECHNICAL FIELD OF THE INVENTION

The present invention generally relates to an arrangement of an embedded imaging module in a display device, and particularly to a structure that replaces a fixed embedded imaging module that is fixed to a display device with a detachable imaging module to allow easy and efficient image taking by a user.

### DESCRIPTION OF THE PRIOR ART

Conventionally, computers, such as portable computers or desktop computers, are often provided with an imaging module embedded therein, and such an imaging module is sometimes referred to as a web cam. Since the conventional web cam is arranged to fix at a central location on a front side of a display device, the operation of the web cam is limited to a certain range of angle and distance and often works for displaying a user sitting in front of the computer. Apparently, the function of the web cam is subjected to severe limitation. In case it is desired to transmit an image of an object or a document or it is desired to capture an image of the site or other landscape, the web cam is incapable to provide long distance imaging. It is thus desirable to make an improvement that converts the existing fixed web cam into a detachable imaging device for free image taking of any specific location.

On the other hand, a regular camera may be provided with an auto-focusing lens, of which the focus can be automatically adjusted in response to the distance and size of an object to be imaged in order to present a clear and complete image of the object. It is thus further desirable to combine such auto-focusing in a detachable imaging module embedded in an electronic device to fully exploit the function of such a detachable arrangement of the imaging device. This is particularly practical for notebook computers that have evolved to become a portable device carried by the general consumers. This, together with the rapid development of band width of Internet transmission, may provide very practical and useful applications in the near future.

### SUMMARY OF THE INVENTION

The present inventor provides an arrangement of an embedded imaging module in a display device, which comprises, in construction, a display device, a detachable imaging module, a retractable cable, and an auto-focusing lens.

In the arrangement of an embedded imaging module in a display device in accordance with the present invention, the display device has a circumferential edge having a corner forming a receiving space to receive the detachable imaging module to be embedded therein. The retractable cable features retractability for connection between the display device and the detachable imaging module to serve a signal transmission line therebetween in both detached and embedded condition of the detachable imaging module.

In the arrangement of an embedded imaging module in a display device in accordance with the present invention, the detachable imaging module comprises the auto-focusing lens, which, together with the detaching or embedding of the detachable imaging module, provides the capability of taking clear and complete images of an object without substantial constraints imposed to the distance and size of the object.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows a schematic perspective view of a display device to which the present invention is applicable.

FIG. 2 is a schematic perspective view illustrating an embodiment of a detachable imaging module in accordance with the present invention detached from the display device.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

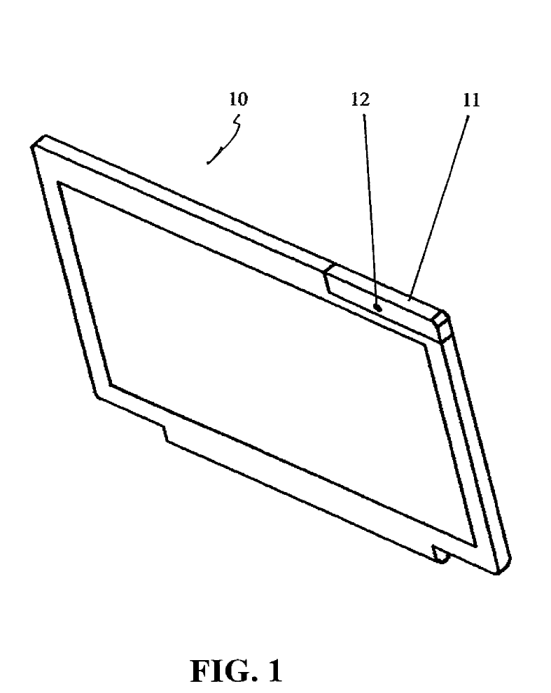

With reference to FIG. 1, which shows a schematic perspective view of a display device to which the present invention is applicable, the display device, generally designated at 10, has a circumferential edge that has a corner at which a detachable imaging module 11 is completely embedded. The imaging module 11 comprises an auto-focusing lens 12.

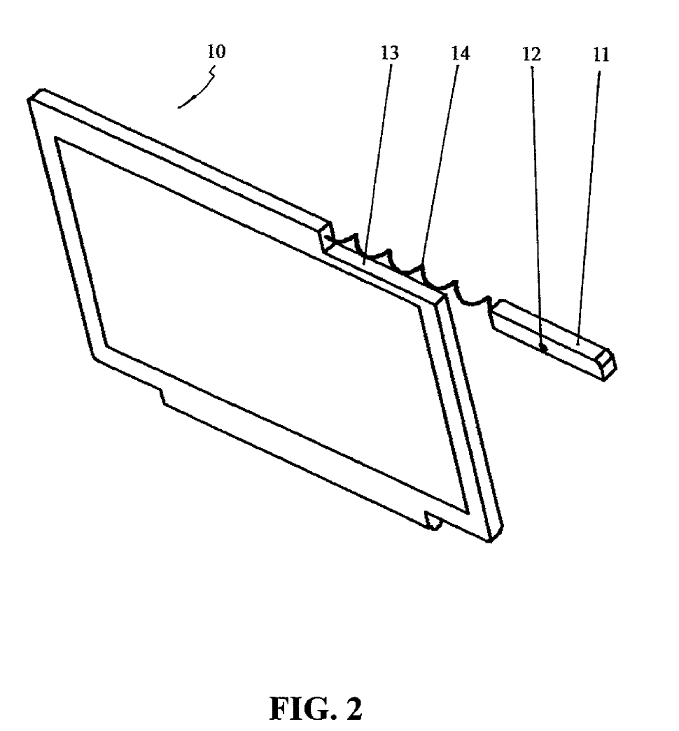

Also referring to FIG. 2, which is a schematic perspective view illustrating an embodiment of the detachable imaging module 11 detached from the display device 10, the corner of the circumferential edge of the display device 10 forms a receiving space 13 in which the detachable imaging module 11 is received. A retractable cable 14 is connected between the display device 10 and the detachable imaging module 11 and the retractability of the cable 14 allows the cable 14 to serve as a signal transmission line in both detached and embedded conditions of the imaging module 11.

Further referring to FIG. 2, since the detachable imaging module 11 is detachable from the display device 10 and since the detachable imaging module 11 includes an auto-focusing lens 12, when the detachable imaging module 11 is detached from the display device 10, the detachable imaging module 11 can be rotated and/or shifted for taking images from different angles. And, since the distance and the size of an object to be imaged are subjected to less or substantially no constraint, complete and clear image of the object can be easily taken with the imaging module 11.

The above discussion is only illustrative, not to limit the scope of the present invention. For example, the coupling between the receiving space of the display device and the detachable imaging module is not limited to what described above and instead, magnetic attraction can be employed or a track-and-slot arrangement can be used. Also, although a retractable cable is described herein for serving a wired transmission between the display device and the detachable imaging module, yet wireless transmission may be instead used with the omission of the cable. For applications of simultaneous transmission of both audio and video signals or applications that need to pick up sounds of an object that is being imaged, a microphone, which can be properly positioned and concealed at a location on the detachable imaging module for simultaneously receiving audio signals.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A structure for arranging an embedded imaging module in a display device, comprising a display device, a detachable imaging module, a retractable cable, and an auto-focusing lens, wherein:
the display device has a circumferential edge having a corner forming a receiving space to receive the detachable imaging module to be embedded therein;
the retractable cable features retractability and connects between the display device and the detachable imaging module to serve a signal transmission line therebetween; and
the detachable imaging module that comprises the auto-focusing lens mounted thereto is detachable from the display device for approaching an object to be imaged.
